(19) United States
(12) Patent Application Publication
(10) Pub. No.: US 2026/0169663 A1
(43) Pub. Date: Jun. 18, 2026

(54) SYSTEM WHICH DIAGNOSES ERROR IN IMAGE FORMATION APPARATUS, METHOD FOR CONTROLLING THE SYSTEM, AND STORAGE MEDIUM

(71) Applicant: CANON KABUSHIKI KAISHA, Tokyo (JP)

(72) Inventor: KENJI KURIBAYASHI, Kanagawa (JP)

(21) Appl. No.: 19/416,507

(22) Filed: Dec. 11, 2025

(30) Foreign Application Priority Data
Dec. 16, 2024 (JP) 2024-219794

(51) Int. Cl. G06F 3/12

(52) U.S. Cl. CPC G06F 3/121; G06F 3/1234

(57) ABSTRACT

A system which diagnoses an error in an image formation apparatus has a diagnosis unit configured to perform, based on a diagnosis instruction of a user, a first diagnosis based on an image outputted from the image formation apparatus, and a second diagnosis based on condition information indicating a state of a part of the image formation apparatus. Then, in a case where an error in the image formation apparatus and a remedy for resolving the error are specified by the first diagnosis or the second diagnosis based on the diagnosis instruction, and an execution of the remedy is confirmed, the diagnosis unit automatically performs the second diagnosis based on the condition information after the execution of the remedy.

### BACKGROUND

### Field of the Technology

The present disclosure relates to a technique of diagnosing an error of an image formation apparatus.

### Description of the Related Art

For an image defect such as so-called streak or spot which has occurred in an image formation apparatus such as a printer or a multi-function printer, a system which provides a cloud-type diagnosis service for automatically specifying a part or the like which is considered to be the cause of the image defect has conventionally been proposed. In the case where an image defect has occurred in an image formation apparatus, the user, maintenance staff, or the like performs a remedy such as cleaning or replacement on the cause part of the image defect which has been specified by the diagnosis service, and confirms whether the image defect has been resolved after the remedy. Regarding this point, Japanese Patent Application Laid-Open No. 2024-49940 discloses an inspection system of a printing apparatus. This inspection system presents a remedy in accordance with a diagnosis result, and in response to the completion of the remedy, allows a re-diagnosis execution instruction to be acceptable.

### SUMMARY

A system which diagnoses an error in an image formation apparatus according to the present disclosure has: one or more memories storing instructions; and one or more processors executing the instructions to: perform, based on a diagnosis instruction of a user, a first diagnosis based on an image outputted from the image formation apparatus, and a second diagnosis based on condition information indicating a state of a part of the image formation apparatus, wherein in a case where an error in the image formation apparatus and a remedy for resolving the error are specified by the first diagnosis or the second diagnosis based on the diagnosis instruction, and an execution of the remedy is confirmed, the second diagnosis based on the condition information after the execution of the remedy is automatically performed.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of a diagnosis system;

FIG. 2A is a diagram showing an example of a hardware configuration of the image formation apparatus; FIG. 2B is a diagram showing an example of a hardware configuration of a server and a client terminal;

FIGS. 3A and 3B are cross-sectional views showing an internal structure of portions involved in a printing operation in the image formation apparatus;

FIG. 4A is a functional block diagram showing a software configuration (logical configuration) of the image formation apparatus. FIG. 4B is a functional block diagram showing a software configuration (logical configuration) of a diagnosis server;

FIG. 5 is a flowchart showing a flow of error resolution processing in the image formation apparatus;

FIG. 6 is a diagram showing an example of a printed product in which an image defect has been occurred;

FIGS. 7A and 7B are examples of UI screens in the case where a user uses a diagnosis service;

FIG. 8 is a flowchart showing a flow of an operation in the image formation apparatus in the case of requesting a diagnosis;

FIG. 9 is a flowchart showing a flow of diagnosis processing in the diagnosis server;

FIG. 10 is a flowchart showing a detail of image diagnosis processing;

FIG. 11A is a diagram showing an example of a scan image of a test chart. FIG. 11B is a diagram showing an analysis result for the scan image;

FIG. 12 is a flowchart showing a detail of condition diagnosis processing;

FIG. 13 is a flowchart showing a flow of an operation to be executed after dealing with an error in the image formation apparatus;

FIGS. 14A and 14B are examples of UI screens based on a diagnosis result;

FIGS. 15A and 15B are examples of UI screens showing results of re-diagnosis;

FIGS. 16A and 16B are graphs showing examples of error determination conditions; and

FIG. 17 is an example of a UI display of a remedy recommended in accordance with a result of image diagnosis in an example.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In the technique of Japanese Patent Application Laid-Open No. 2024-49940, in the case where an instruction to perform re-diagnosis is received from the user after execution of a remedy presented to the user, a test chart is printed, and processing of determining the presence or absence of an image defect is performed. In this way, the user can check whether the image defect has been resolved after the remedy of part replacement or the like. However, according to the study made by the present inventors, the work of instructing execution of re-diagnosis after a remedy of part replacement or the like to check whether an image defect has been resolved requires time and effort for the user. On the other hand, there is also a problem that in the case where re-diagnosis has not been performed after a remedy, a sales company or the like cannot find whether an image defect has been resolved.

### First Embodiment

### <System Configuration>

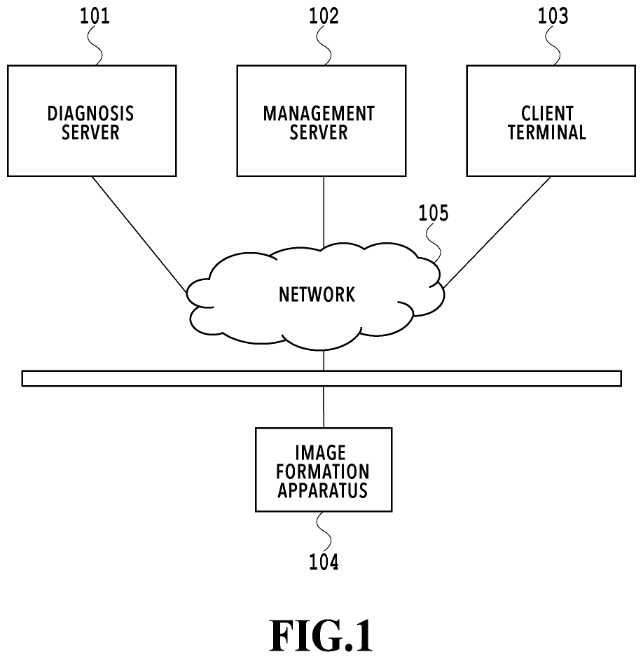

FIG. 1 is a diagram showing an example of a configuration of a system which provides a service of diagnosing an error of an image formation apparatus online according to the present embodiment (hereinafter, referred to as a “diagnosis system”). The diagnosis system shown in FIG. 1 includes a diagnosis server 101, a management server 102, a client terminal 103, an image formation apparatus 104, and a network 105. The diagnosis server 101 and the management server 102 are operated by a third party (for example, a sales company) in charge of sales·maintenance management of the image formation apparatus 104. In addition, the client terminal 103 is used by the user or maintenance staff of the image formation apparatus 104.

The diagnosis server 101 obtains image data and condition information of each part, which are transmitted from the image formation apparatus 104 via the network 105, and performs diagnosis of an error occurring in the image formation apparatus 104 and re-diagnosis after dealing with the error. The management server 102 collects and accumulates, via the network 105, user information such as ID which uniquely identifies a user who uses the diagnosis service, information indicating a device state such as part replacement event and resolution status of an error, which are transmitted from the image formation apparatus 104, and the like.

The client terminal 103 is used, via the network 105, for inputting a print job into the image formation apparatus 104, browsing a result of a diagnosis by the diagnosis server 101, and checking the state of the image formation apparatus 104. The client terminal 103 is an information processing apparatus such as a laptop PC or a smartphone, for example.

The image formation apparatus 104 is a multi-function printer (MFP) having a printing function, a copy function, a scanner function, a FAX function, and the like. However, the image formation apparatus 104 is not limited to a multi-function printer, and only has to be an apparatus having an image forming function, such as a single-function printer (SFP), a facsimile apparatus, or a scanner apparatus, for example.

### <Hardware Configurations>

### <<Hardware Configuration of Image Formation Apparatus>>

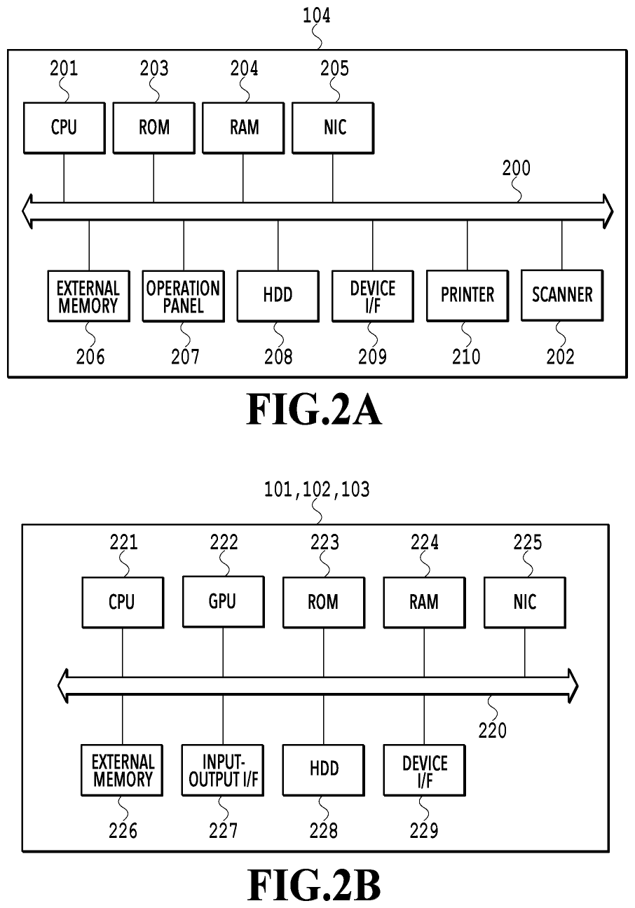

FIG. 2A is a diagram showing an example of a hardware configuration of the image formation apparatus 104 according to the present embodiment. The image formation apparatus 104 includes a CPU 201, a ROM 203, a RAM 204, an NIC 205, an external memory 206, an operation panel 207, an HDD 208, a device I/F 209, a printer 210, and a scanner 202. These components are connected via a system bus 200.

CPU 201 is an arithmetic processing apparatus which centrally controls the image formation apparatus 104. The CPU 201 implements each functional unit shown in a software configuration, which will be described later, by reading out a control program, resource data, and the like stored in the ROM 203 or the external memory 206 onto the RAM 204, and executing these. The ROM 203 stores various programs such as a basic I/O program, and also various pieces of data such as font data for use in document processing. The RAM 204 functions as a main memory, a work area, and the like for the CPU 201. The RAM 204 is configured such that the memory capacity of the RAM 204 can be extended by using an option RAM which is connected to an extension port which is not shown. The NIC (network interface card) 205 is an interface with an external apparatus, and the image formation apparatus 104 communicates data with the external apparatus via the NIC 205.

The operation panel 207 is configured with hard buttons, a liquid crystal panel, and the like, and displays various user interface screens (hereinafter, referred to as “UI screens”), and receives operation instructions of the user via the UI screens. The HDD 208 is a large-capacity storage apparatus which stores various pieces of image data, and also tables, set values, and the like. The device I/F 209 is a connection interface with an external device, such as a USB, for example.

The printer 210 interprets PDL (Page Description Language) or PDF (Portable Document Format) contained in a print job, generates image data for printing, and forms an image on a printing medium such as paper by means of any desired printing system. The printing system includes an electrophotographic system (laser beam system), an inkjet system, a sublimation (thermal transfer) system, and the like. The scanner 202 optically reads an original document set on an ADF (Auto Document Feeder) or placed on a platen glass, which is not shown, and generates image data (scan image data).

### <<Hardware Configuration of Server/Client Terminal>>

With reference to FIG. 2B, a hardware configuration of the diagnosis server 101, the management server 102, and the client terminal 103 according to the embodiment of the present invention will be described. All of the diagnosis server 101, the management server 102, and the client terminal 103 are information processing apparatuses, and the hardware configurations thereof are basically the same.

Each of the diagnosis server 101, the management server 102, and the client terminal 103 includes a CPU 221, a GPU 222, a ROM 223, a RAM 224, an NIC 225, an external memory 226, an input-output I/F 227, an HDD 228, a device I/F 229. These components are connected via a system bus 220.

The CPU 221 is an arithmetic processing apparatus which centrally controls each server 101/102 or the client terminal 103 serving as an information processing apparatus. The CPU 221 implements predetermined functions by reading out a control program, resource data (resource information), and the like stored in the ROM 223 onto the RAM 224, and executing these. The GPU 222 is an arithmetic device dedicated to vector operations such as image processing and machine learning. The ROM 223 stores various programs such as a basic I/O program, and the like. The RAM 224 functions as a main memory, a work area, and the like for the CPU 201. The RAM 224 is configured such that the memory capacity of the RAM 224 can be extended by using an option RAM which is connected to an extension port which is not shown. The NIC (network interface card) 225 is an interface with an external apparatus, and each server or client terminal communicates data with the external apparatus via the NIC 205. The input-output I/F 227 is an interface with an input device such as a mouse or a keyboard or an output device such as a display. The HDD 228 is a large-capacity storage apparatus which stores image data, set values, and the like. The device I/F 229 is a connection interface with an external device, such as a USB, for example.

### <Internal Structure of Image Formation Apparatus>

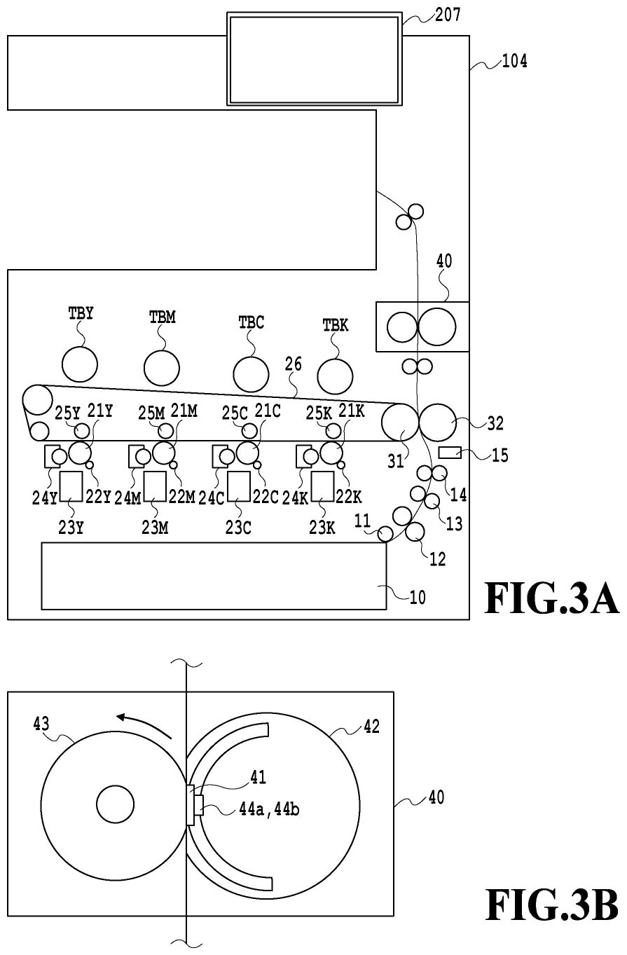

FIGS. 3A and 3B are cross-sectional views showing an internal structure of portions involved in a printing operation in the image formation apparatus 104. First, with reference to FIG. 3A, the printing operation of forming an image on a sheet P with an electrophotographic system will be described. The image formation apparatus 104 of the present embodiment can perform so-called full-color printing by using toners of four colors of yellow (Y), magenta (M), cyan (C), and black (K). In FIG. 3A, members and the like denoted by reference signs with only numbers are portions common to drum cartridges of four colors.

The image formation apparatus 104 includes one or more feeding cassettes 10. A pick roller 11 picks up the sheet P stored in the feeding cassettes 10, and feeds the sheet P to a conveyance path. Separating rollers 12 are conveyance rollers which, in the case where a plurality of the sheets P are led out, separate only the uppermost sheet P and further convey the sheet P downstream. Pre-regi rollers 13 provided downstream of the separating rollers 12 are conveyance rollers which further convey the sheet P downstream. The term “regi” is abbreviation of registration. Regi rollers 14 provided downstream of the pre-regi rollers 13 are conveyance rollers which convey the sheet P further downstream. A regi sensor 15 provided downstream of the regi rollers 14 outputs a signal indicating that the sheet P is passing therethrough, during a period of time from when the regi sensor 15 detects the leading end of the sheet P to when the regi sensor 15 detects the trailing end of the sheet P. Note that a conveyance time from when the drive of the pick roller 11 is instructed to when the regi sensor 15 detects the leading end of the sheet P is monitored in order to detect a conveyance delay or a jam.

Image formation on the sheet P is performed as follows. First, the surface of a photosensitive drum 21 is uniformly charged by a charger 22. By exposing this charged surface with a laser 23, an electrostatic latent image is formed on the photosensitive drum 21. By attaching a toner to the electrostatic latent image thus obtained from a developer 24, the electrostatic latent image is developed as a toner image. This toner image is transferred onto an intermediate transfer belt 26 by a primary transfer roller 25. In addition, in the case where the amount of the toner stored inside the developer 24 becomes lower than a predetermined amount due to the image formation, the toner is repeatedly supplied to the developer 24 from a toner reservoir unit. In the case where the amount of the toner stored inside the toner reservoir unit becomes lower than a predetermined amount, the toner of the corresponding color is repeatedly supplied to the toner reservoir unit from a toner bottle TB.

In parallel with the above-mentioned toner image forming operation, the sheet P is conveyed from a feeding cassette 10 through the conveyance path to the regi rollers 14 one by one. The regi rollers 14 correct an oblique movement of the sheet P. After the oblique movement is corrected, the sheet P is conveyed to a secondary transfer unit by the regi rollers 14. The toner images of a plurality of colors, which have been transferred on one another on the intermediate transfer belt 26 are transferred onto the conveyed sheet P in the secondary transfer unit where a secondary transfer inner roller 31 and a secondary transfer outer roller 32 abut each other. The toner images on the sheet P are heated and pressurized by a fixing mechanism 40 to be fixed, and then, the sheet P is discharged to the outside of the image formation apparatus 104.

The secondary transfer unit includes the secondary transfer inner roller 31 and the secondary transfer outer roller 32. The secondary transfer inner roller 31 is disposed to face the secondary transfer outer roller 32 via the intermediate transfer belt 26. The secondary transfer outer roller 32 is in contact with the intermediate transfer belt 26 to form the secondary transfer unit between the secondary transfer outer roller 32 and the intermediate transfer belt 26. A secondary transfer voltage having a polarity opposite to that of the toners is applied to the secondary transfer unit, so that the secondary transfer outer roller 32 secondarily transfers the toner images on the intermediate transfer belt 26 to the sheet P fed to the secondary transfer unit. The core of the secondary transfer inner roller 31 is connected to the ground potential.

FIG. 3B shows a cross-sectional configuration of the fixing mechanism 40. The fixing mechanism 40 includes: a fixing film 42 in which a heating heater 41 is disposed; and a pressing roller 43 which forms a fixing nip with the heating heater 41 and transmits the drive to the fixing film 42. The heating heater 41 heats the fixing film 42 at the fixing nip portion. In addition, the fixing mechanism 40 includes a first thermistor 44a and a second thermistor 44b as temperature detection units which detect the temperature of the heating heater 41.

### <Operation Control of Image Formation Apparatus>

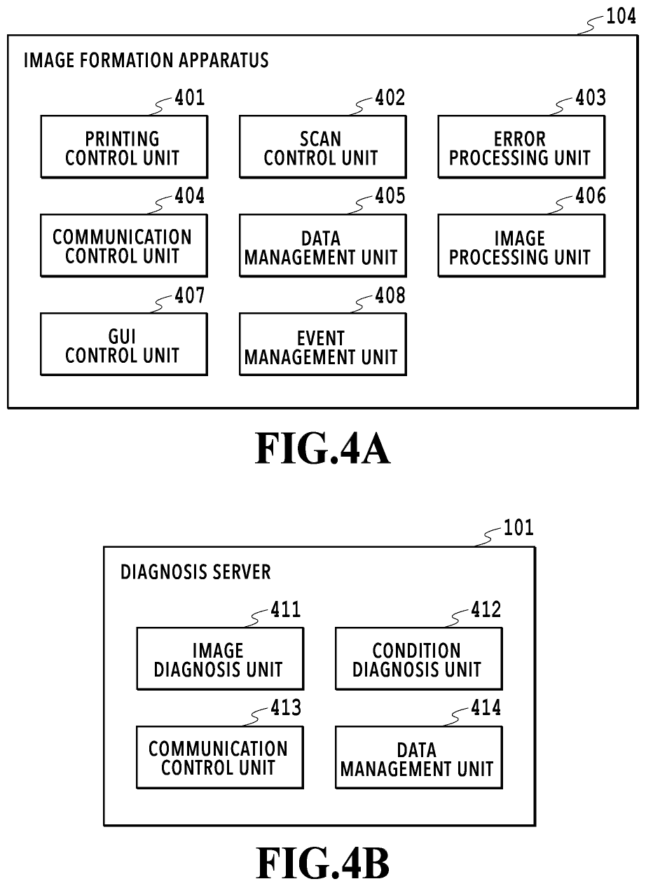

Subsequently, an operation control of the image formation apparatus 104 in the diagnosis system of the present embodiment will be described with reference to the drawings. As shown in FIG. 4A, the image formation apparatus 104 includes a printing control unit 401, a scan control unit 402, an error processing unit 403, a communication control unit 404, a data management unit 405, an image processing unit 406, a GUI control unit 407, and an event management unit 408. Hereinafter, the operation control implemented by the functional units of the image formation apparatus 104 will be described by using a flowchart.

### <<Error Processing>>

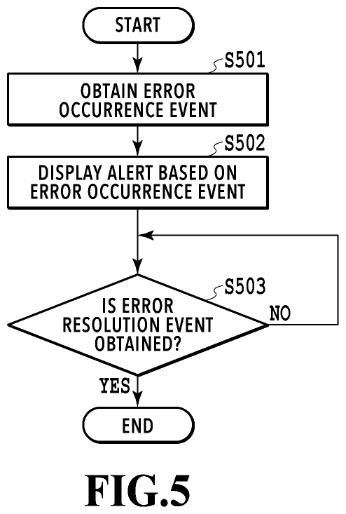

FIG. 5 is a flowchart showing a flow of processing which is performed by the error processing unit 403 in order to resolve an error in the case where the error has occurred in the image formation apparatus 104. The series of processes shown by the flowchart of FIG. 5 is started in response to detection of an occurrence of an error. Note that in the following description, sign “S” means a step.

In S501, an event indicating an occurrence of an error is obtained by the event management unit 408. The event management unit 408 obtains, as event information, for example, information relating to various events which can occur in the image formation apparatus 104, such as information indicating an occurrence/resolution of an error, information indicating start/completion of part replacement, information indicating start/completion of shipment of a part, and the like. For example, in the case where a sensor has detected that the remaining amount of the toner in the toner bottle, which is an expendable part, has become smaller than a predetermined amount, an error occurrence event indicating this fact is obtained.

In S502, based on the error event obtained in S501, an alert corresponding to the detected error is displayed. For example, in the case where an error of “Toner Low” has been detected because the remaining amount of the toner bottle has become below a predetermined amount, a UI screen (not shown) containing an alert message urging the replacement of the target toner bottle is displayed on the operation panel 207 by the GUI control unit 407.

In S503, it is determined whether an event indicating resolution of the error is obtained from the event management unit 408. For example, in the example in which the detected error is the above-mentioned “Toner Low”, in the case where a sensor has detected the replacement of the target toner bottle, and an error resolution event has been obtained, the present processing is ended. On the other hand, in the case where an error resolution event has not been obtained, determination on whether an error resolution event has been obtained is repeated again after a predetermined time has elapsed.

The processing to be executed by the error processing unit 403 in the case where an error has occurred in the image formation apparatus 104 is as described above. In this way, if an occurrence of an error has been detected, the processing for resolving the error is performed.

### <<Situation Where Diagnosis Service Is Applied>>

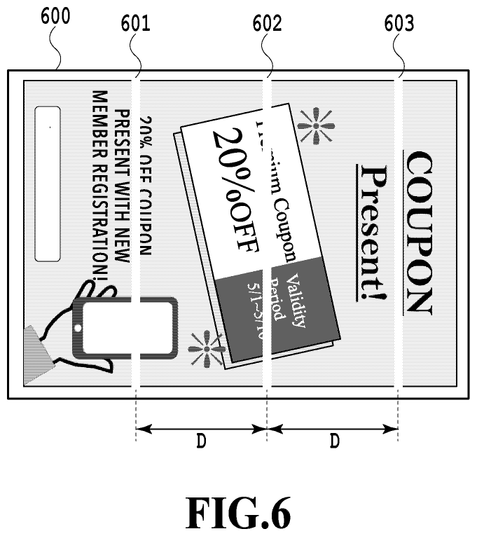

As a situation where the diagnosis service according to the present embodiment is applied, for example, there could be a case where while the user loaded a print job because the user replaced the toner bottle based on the above-mentioned alert display and an error was resolved, a defect (image defect) has occurred in a printed product. Types of image defects include, for example, a dot-shaped defect called “spot”, a line-shaped defect called “streak”, and also density unevenness, and the like. FIG. 6 is a diagram showing an example of a printed product in which streaks have been occurred. In a printed product 600 of FIG. 6, three vertical streaks 601 to 603 have been occurred. Then, the three streaks 601 to 603 have appeared periodically at an interval of a distance D. Upon the generation of such an image defect, the user deals with the image defect by using the diagnosis service provided by the diagnosis server 101.

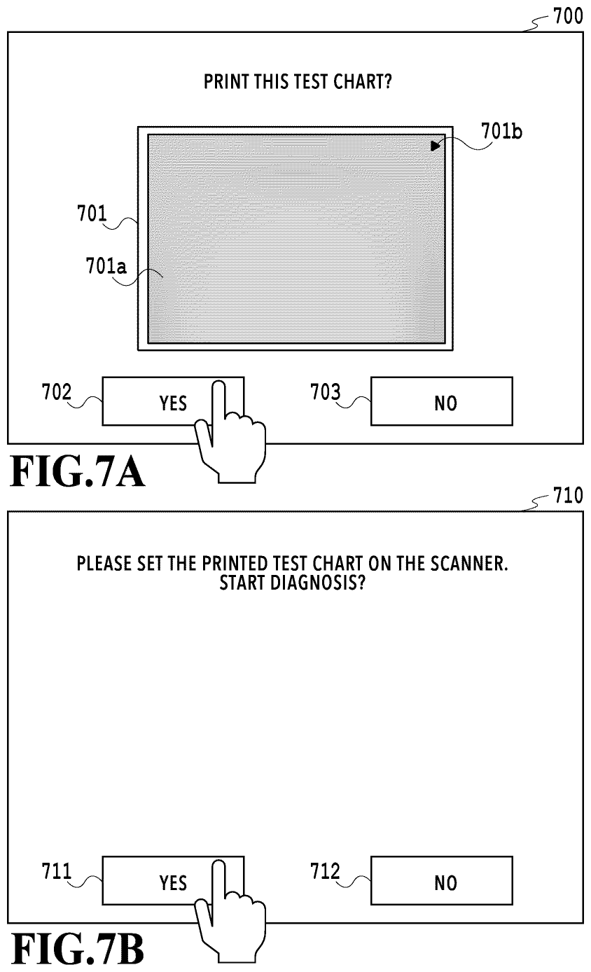

FIGS. 7A and 7B are examples of UI screens in the case where the user uses the diagnosis service, and are displayed on the operation panel 207 of the image formation apparatus 104 by the GUI control unit 407. A UI screen 700 of FIG. 7A is a UI screen for printing a test chart for image diagnosis. The UI screen 700 contains a test chart image 701, a “Yes” button 702 which is pressed down in the case of executing printing of the test chart image, and a “No” button 703 which is pressed down in the case of not executing the printing. The test chart image 701 contains a monochrome solid region 701a and a mark 701b which indicates a sheet conveyance direction at the time of printing. The mark 701b may be, for example, a two-dimensional or one-dimensional code, or may be information written into text form. Note that although the description is omitted here, it is assumed that in the case where the user has made an instruction of printing a test chart via the UI screen 700, printing of the test chart image corresponding to each color material (four colors of CMYK in the present embodiment) included in the image formation apparatus 104 is executed.

FIG. 7B is an example of a UI screen in the case where the user pressed down the “Yes” button 702 in the UI screen 700 of FIG. 7A to scan a test chart outputted from the image formation apparatus 104, and requests the diagnosis server 101 to perform the diagnosis. The UI screen 710 of FIG. 7B contains a “Yes” button 711 in the case of requesting the diagnosis and a “No” button 712 in the case of not requesting the diagnosis, in addition to a message which urges the user to set the outputted test chart on the scanner 202. In the case where the “Yes” button 711 is pressed down, the scanner 202 executes reading (scan) of the set test chart, and a diagnosis request for a scan image thus obtained is transmitted to the diagnosis server 101.

### <<Operation Flow at Time of Requesting Diagnosis>>

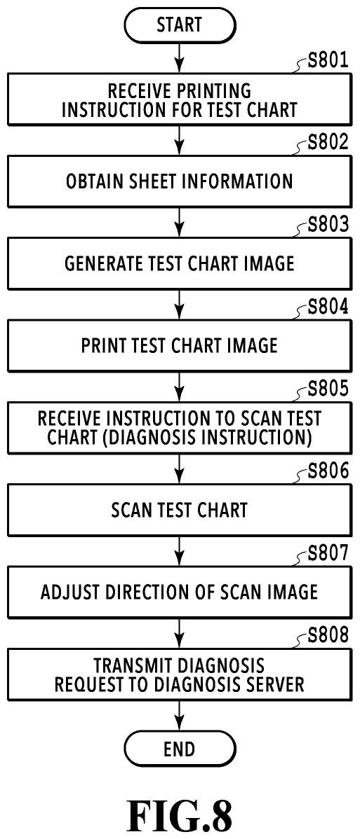

FIG. 8 is a flowchart showing a flow of an operation in the image formation apparatus 104 in the case where the user requests the diagnosis server 101 to perform the diagnosis. The series of processes shown by the flowchart of the FIG. 8 is started by the user causing the UI screen 700 of the aforementioned FIG. 7A to be displayed on the operation panel 207. Note that in the following description, sign “S” means a step.

In S801, the GUI control unit 407 receives a printing instruction (detection of the press down of the “Yes” button 702 in the UI screen 700 of the aforementioned FIG. 7A) by the user. In subsequent S802, sheet-size information on the sheet set in the feeding cassette is obtained from the HDD 208 via the data management unit 405. In next S803, the image processing unit 406 generates a necessary number of the aforementioned test chart images corresponding to the sheet size indicated by the sheet-size information obtained in S802. Then, in S804, the printing control unit 401 controls the printer 210 to execute printing based on the test chart images generated in S803. After the test charts are printed in this way, the user sets the test chart on the scanner 202 in accordance with the UI screen 710 of the aforementioned FIG. 7B, which is displayed on the operation panel 207.

In S805, the GUI control unit 407 receives a diagnosis instruction (detection of the press down of the “Yes” button 711 in the UI screen 710 of the aforementioned FIG. 7B: a reading instruction) by the user. In subsequent S806, the scan control unit 402 controls the scanner 202 to execute scan of the test chart set by the user on the platen glass, which is not shown. In next S807, the image processing unit 406 performs predetermined image processing on the scan image of the test chart, which is obtained in S806, such as rotating the scan image to a direction corresponding to the conveyance direction. Then, in S808, the communication control unit 404 transmits a diagnosis request to the diagnosis server 101 via the network 105. In this event, data of the scan image of the test chart, which is obtained in S807, as attachment data indicating the diagnosis subject, is associated and transmitted with the diagnosis request.

The flow of the operation in the image formation apparatus 104 in the case where the user requests the diagnosis server 101 to perform a diagnosis is as described above.

### <Operation Control of Diagnosis Server>

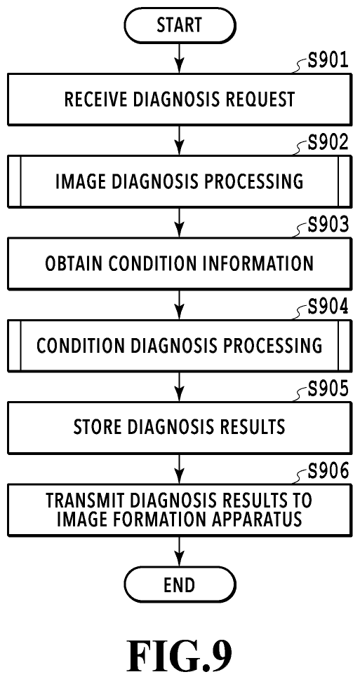

Subsequently, an operation control of diagnosis processing based on a diagnosis request in the diagnosis server 101 will be described with reference to the drawings. As shown in FIG. 4B, the diagnosis server 101 includes an image diagnosis unit 411, a condition diagnosis unit 412, a communication control unit 413, and a data management unit 414. FIG. 9 is a flowchart showing a flow of processing to be executed in the diagnosis server 101 which has received a diagnosis request from the image formation apparatus 104. The diagnosis server 101 of the present embodiment performs two types of diagnosis processing upon receipt of a diagnosis request. One of the diagnosis processing is image diagnosis processing using a scan image of a test chart, which is attachment data of the diagnosis request, and the other is condition diagnosis processing using condition information of the image formation apparatus 104. Hereinafter, referring to the flowchart, the operation control achieved by each functional unit of the diagnosis server 101 will be described. Note that in the following description, sign “S” means a step.

In S901, the communication control unit 411 receives a diagnosis request from the image formation apparatus 104. The scan image data of the test chart, which is attachment data of the received diagnosis request, is stored in the HDD 228 by the data management unit 414, and is read out and subjected to the image diagnosis processing by the image diagnosis unit 411.

In S902, the image diagnosis unit 411 performs the image diagnosis processing on the scan image of the diagnosis request received in S901. The detail of the image diagnosis processing will be described later.

In S903, the data management unit 414 reads out and obtain, from the HDD 228, condition information which is stored in advance. Here, the condition information contains detection values of various sensors provided in the image formation apparatus 104, and the like. This condition information is, for example, such that the communication control unit 413 receives condition information which is periodically transmitted from the image formation apparatus 104 through a push system and stores the condition information in the data management unit 405. Alternatively, the communication control unit 413 may receive condition information from the image formation apparatus 104 through a polling system, and store the condition information in the data management unit 405.

In S904, the condition diagnosis unit 412 performs the condition diagnosis processing based on the condition information obtained in S903. The detail of the condition diagnosis processing will be described later.

In S905, the data management unit 405 integrates a result of the image diagnosis processing of S902 and a result of the condition diagnosis processing of S904, and stores the results in the HDD 228. For example, the results are stored in a table format, like the following Table 1, in which the result of the image diagnosis processing and the result of the condition diagnosis processing are combined for each part included in the image formation apparatus 104.

TABLE 1

| | Result | Result of |
|---|---|---|
| | of image | condition |
| Part name | diagnosis | diagnosis |
| Photosensitive drum (C) | Erroneous | Normal |
| Photosensitive drum (M) | Normal | Normal |
| Photosensitive drum (Y) | Normal | Normal |
| Photosensitive drum (K) | Erroneous | Erroneous |
| Transfer belt | Normal | Normal |
| Transfer roller | Normal | Normal |
| Fixing unit | Normal | Normal |
| . | . | . |
| . | . | . |
| . | . | . |

In the above-mentioned Table 1, although the result of image diagnosis is “Image defect is present” for the photosensitive drum (C) and the photosensitive drum (K), the result of condition diagnosis is “Normal” for the photosensitive drum (C), and “Erroneous” for the photosensitive drum (K). It can be surmised that the causes of such statuses are that a foreign matter was mixed for the photosensitive drum (C), and that a scratch was formed for the photosensitive drum (K).

In S906, the communication control unit 413 transmits the diagnosis results stored in S905 to the image formation apparatus 104, which is a transmission source of the diagnosis request received in S901. In this event, the diagnosis results may be transmitted after the result obtaining request from the image formation apparatus 104 is received. In addition, the communication control unit 413 associates the stored diagnosis results with the image formation apparatus 104, and transmits the diagnosis results to the management server 102. The flow of the operation of the diagnosis processing in the diagnosis server 101 is as described above.

### <<Detail of Image Diagnosis Processing>>

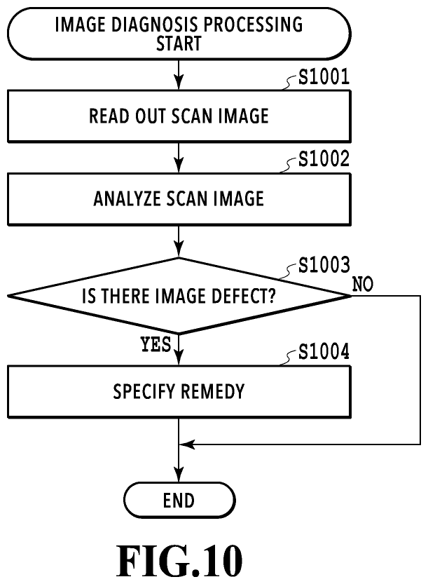

FIG. 10 is a flowchart showing a detail of the image diagnosis processing (S902) in the flow of the aforementioned FIG. 9. Hereinafter, a detailed description will be made with reference to the flowchart of FIG. 10.

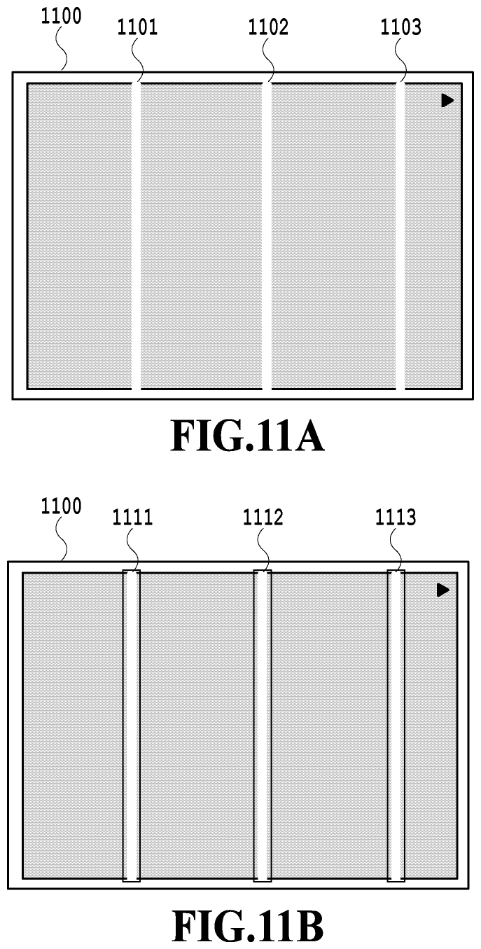

In S1001, scan image data of a test chart to be subjected to the image diagnosis processing is read out from the HDD 228 via the data management unit 414. FIG. 11A is an example of a scan image of a test chart outputted to be printed. In the scan image 1100 of FIG. 11A, three vertical streaks 1101 to 1103 have been occurred periodically in the same manner as in the printed product of the aforementioned FIG. 6.

In S1002, the scan image read out in S1001 is subjected to analysis processing of specifying the presence or absence of an image defect (printing defect), and also the type, the position, and the presence or absence of periodicity in the case where there is an image defect. This analysis processing uses, for example, a learned model which is obtained by training with pairs of scan images of various test charts and their ground truth data (the types, positions, periodicities of image defects) as learning data. Alternatively, an approach of determining the presence or absence of an image defect by comparing a ground truth image (a test chart image with no defects) of a test chart, which is prepared in advance, and a scan image may be employed. FIG. 11B is a diagram showing an analysis result for the scan image 1100 shown in above-mentioned FIG. 11A. In FIG. 11B, bounding boxes 1111 to 1113 which surround the respective three vertical streaks on the scan image 1100 indicate regions which have been detected as image defects. By such analysis processing, an analysis result as shown in Table 2 given below, for example, can be obtained from one scan image.

TABLE 2

| Image | Type | | | | | | | |
|---|---|---|---|---|---|---|---|---|
| defect | of | X | Y | Width | Height | | | |
| ID | defect | coordinate | coordinate | (W) | (H) | . . . | Periodicity | Cause part |
| 1 | Vertical | x1 | y1 | w1 | h1 | . . . | Present | Photosensitive |
| | streak | | | | | | | drum (C) |
| 2 | Spot | x2 | y2 | w2 | h2 | . . . | Present | Photosensitive |
| | | | | | | | | drum (K) |

In the above-described Table 2, in the X coordinate and the Y coordinate, vertex coordinates (for example, pixel values) of the upper left corner of the bounding box are entered. In the Height and the Width, the height and the width (for example, pixel values) of the bounding box are entered. In addition, the Periodicity is determined to be “Present” in the case where an interval between adjacent bounding boxes in the X coordinate or the Y coordinate is constant.

In S1003, processing to be executed next is switched depending on whether an image defect has been found in the analysis processing of S1002. If an image defect has been found, S1004 is executed next. On the other hand, if an image defect has not been found, the present processing is finished.

In S1004, a remedy for the image defect found in S1002 is specified. The remedy to be specified here includes registration adjustment and the like which is automatically executed in the apparatus, and also cleaning and replacement of a part or the like which caused the image defect, repair of a part by a service person, and the like. For specifying a remedy, for example, a pre-prepared table, which is not shown, in which remedies (cleaning, repair, replacement, and the like) for each cause part, which are surmised from the types and positions, the presence or absence of periodicity, and the like of image defects are specified is referred to.

The content of the image diagnosis processing is as described above. Note that although in the flow of FIG. 10, a remedy for the image defect is specified in the case where the image defect has been found, for example, the determination on the presence or absence of an image defect and the specification of a remedy in the case where there is the image defect may be performed at once by using a learned model which performs the determination and the specification together.

### <<Detail of Condition Diagnosis Processing>>

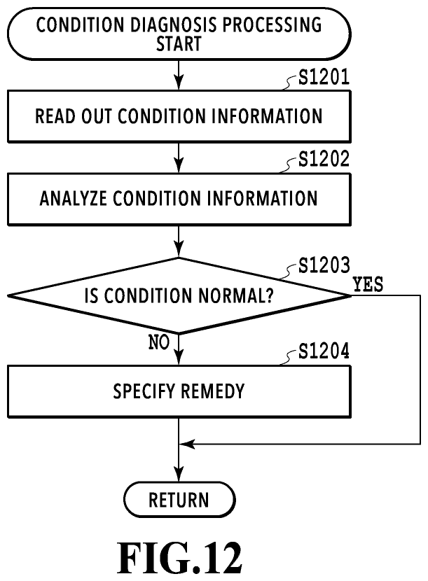

FIG. 12 is a flowchart showing a detail of the condition diagnosis processing (S904) in the flow of FIG. 9. Hereinafter, a detailed description will be made with reference to the flowchart of FIG. 12.

In S1201, condition information to be subjected to the condition diagnosis processing is read out from the HDD 228 via the data management unit 414. In the case of the present embodiment, values of various parameters used in the control of the image formation, for example, a drum charge current value, a primary transfer current value, a secondary transfer current value, a temperature of the fixing thermistor, and the like are read out as the condition information.

In S1202, analysis processing using error determination conditions (for example, thresholds which specify ranges of normal parameter values) set in advance for the respective parameters, for example, is performed on the condition information read out in S1201. Note that an approach using learned models which have been caused to learn for the condition diagnosis may be employed in place of the approach using error determination conditions.

In S1203, processing to be executed next is switched depending on whether there is a part for which it has been determined that a condition error has occurred in the analysis processing of S1202. If there is a part for which a condition error has occurred, S1204 is executed next. On the other hand, if there is no part for which a condition error has occurred, the present processing is finished.

In S1204, a remedy for the condition error found in S1202 is specified. The remedies to be specified here include cleaning of a part, replacement of the part, repair by a service person of the part which has caused the condition error. For specifying a remedy, for example, a pre-prepared reference table (a table in which each parameter and a part or the like relating to the parameter are associated with each other) shown in Table 3 given below for specifying a cause of a condition error is used.

TABLE 3

| Parameter | Corresponding part | | |
|---|---|---|---|
| Drum charge | Photosensitive | — | — |
| current value | drum | | |
| Primary transfer | Photosensitive | Intermediate | . . . |
| current value | drum | transfer belt | |
| Secondary transfer | Intermediate | Secondary transfer | . . . |
| current value | transfer belt | outer roller | |
| Thermistor | Fixing unit | — | — |
| temperature | | | |
| . | . | . | . |
| . | . | . | . |
| . | . | . | . |

The content of the condition diagnosis processing is as described above. Note that although in the flow of FIG. 12, a remedy for a condition error is specified in the case where the condition error has been found, the configuration is not limited to this. For example, the determination on the presence or absence of a condition error and the specification of a remedy in the case where there is the condition error may be performed at once by using a learned model which performs the determination and the specification together.

### <Operation Flow of Image Formation Apparatus After Receiving Diagnosis Result>

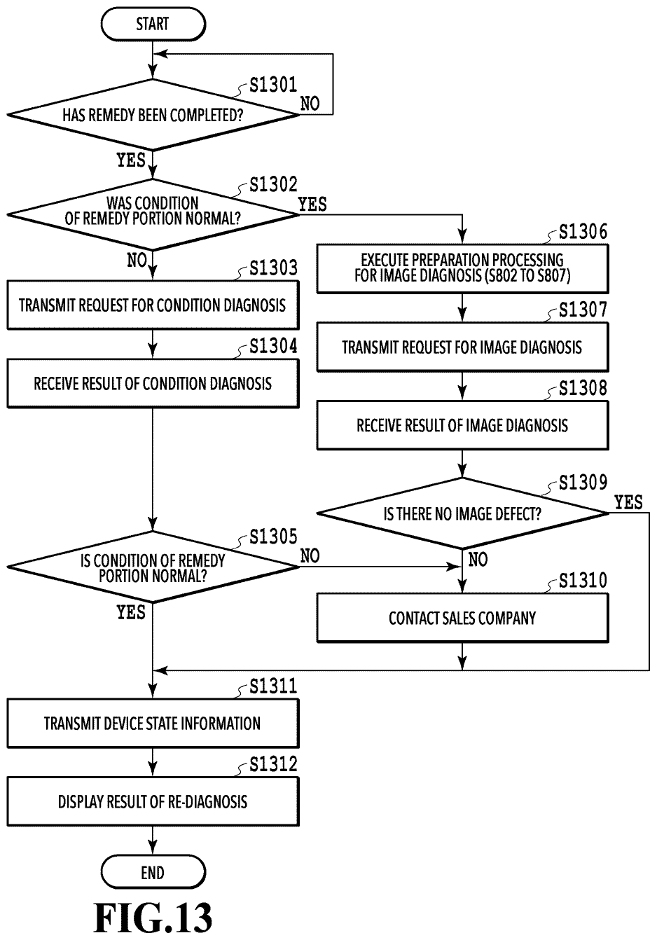

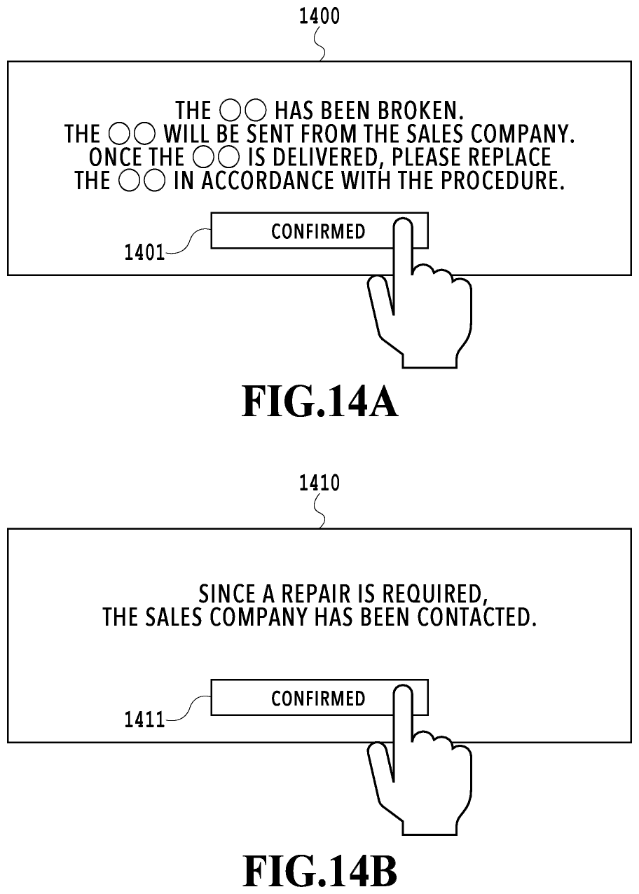

Subsequently, a flow of an operation which is executed after dealing with an error in the image formation apparatus 104 which has received a diagnosis result based on a diagnosis request will be described with reference to a flowchart of FIG. 13. Before execution of a series of processes shown by the flowchart of the FIG. 13, the GUI control unit 407 of the image formation apparatus 104 displays, on the operation panel 207, a UI screen for presenting a remedy for an error which has been found by the diagnosis to the user, or the like. FIGS. 14A and 14B are examples of UI screens based on a diagnosis result. A diagnosis result screen 1400 of FIG. 14A displays a message indicating that a certain part has been broken, a message indicating that a part for replacement has been shipped from the sales company, and further a message urging the user to replace the part. A confirmation button 1401 is a button for closing this UI screen. A diagnosis result screen 1410 of FIG. 14B displays a message indicating that a repair by a service person is required, and the sales company has been notified of that effect. A confirmation button 1411 is a button for closing this UI screen. Note that in the case where there are a plurality of remedy portions, processing after the error remedy is executed for each remedy portion. In the following description, sign “S” means a step.

In S1301, it is determined whether or not the remedy for the error found by the diagnosis has been completed. In this event, for example, in the case where the presented remedy is cleaning or repair of the cause part, the completion of the remedy is determined in accordance with the user or the service person, for example, inputting that effect that the work has been completed, via a predetermined UI screen (not shown). In addition, for example, in the case where the presented remedy is replacement of the cause part, the completion of the remedy may be determined by automatically detecting attachment and detachment of this part by using a sensor, for example. If it is determined that the remedy has not been completed, it is determined whether the remedy has been completed again after a predetermined time has elapsed. On the other hand, if it is determined that the remedy has been completed, S1302 is executed next.

In S1302, processing to be executed next is switched depending on whether or not the condition was normal in a diagnosis result before the execution of the remedy for the remedy portion. If the condition before the execution of the remedy was not normal, S1303 is executed next. On the other hand, if the condition before the execution of the remedy was normal, S1306 is executed next.

In S1303, the communication control unit 404 transmits a request for condition diagnosis to the diagnosis server 101 via the network 105. The diagnosis server 101 which has received this request executes the aforementioned condition diagnosis processing (the flow of FIG. 12), and returns the result to the image formation apparatus 104. In subsequent S1304, the communication control unit 404 receives the result of the condition diagnosis, which has been transmitted by the diagnosis server 101.

In S1305, processing to be executed next is switched depending on whether the condition of the remedy portion is normal, based on the result of the condition diagnosis, which has been received in S1305. If the condition is normal, S1311 is executed next. On the other hand, if the condition is not normal, S1310 is executed next.

In S1306, preparation processing (each processing of S802 to S807 in the flow of the aforementioned FIG. 8, for example) for performing image diagnosis processing is executed. In next S1307, the communication control unit 404 transmits a request for image diagnosis together with scan image data of a test chart to the diagnosis server 101 via the network 105. The diagnosis server 101 which has received the request for image diagnosis executes the aforementioned image diagnosis processing (the flow of FIG. 10), and returns the result to the image formation apparatus 104. In subsequent S1308, the communication control unit 404 receives the result of the image diagnosis, which has been transmitted by the diagnosis server 101.

In S1309, processing to be executed next is switched depending on whether or not there is an image defect, based on the result of the image diagnosis, which has been received in S1308. If there is no image defect, S1311 is executed next. On the other hand, there is an image defect, S1310 is executed next.

In S1310, regarding the remedy portion, the communication control unit 404 notifies the sales company of the fact that there is a condition error or an image defect even after the execution of the remedy, by e-mail or the like.

In S1311, the communication control unit 404 transmits device state information containing, for example, a part replacement event or an error resolution event after the execution of the remedy to the management server 102. In addition, the communication control unit 404 may transmits the device state information to the client terminal 103. Note that the transmission of the device state information may be performed based on a request from the management server 102 or the client terminal 103.

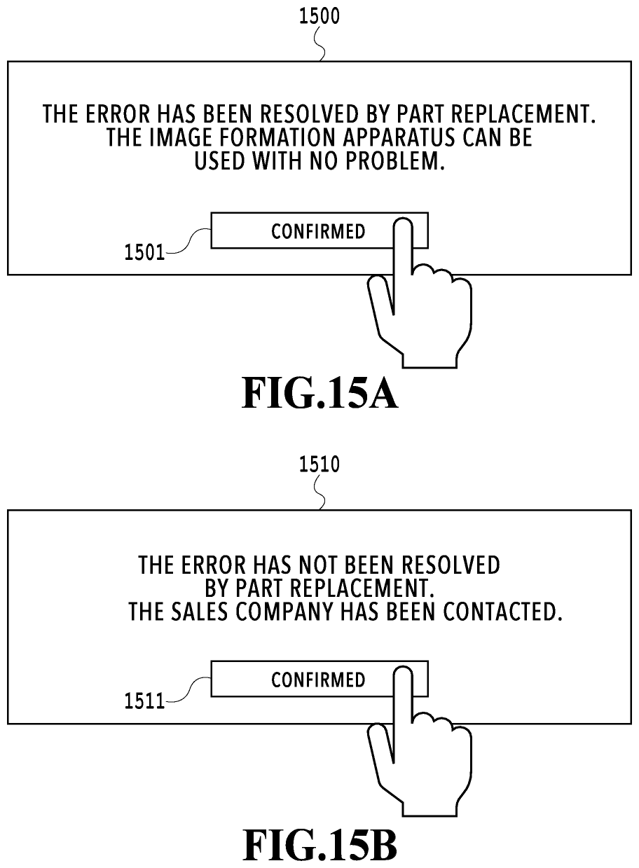

In S1312, the GUI control unit 407 displays, on the operation panel 207, a UI screen showing the result of the condition diagnosis, which has been received in S1304, or the result of the image diagnosis, which has been received in S1308. FIGS. 15A and 15B are examples of UI screens showing results of re-diagnosis automatically performed after the execution of the remedy. A re-diagnosis result screen 1500 of FIG. 15A displays a message indicating that the error has been resolved by part replacement, and the image formation apparatus 104 can be used with no problem. A confirmation button 1501 is a button for closing this UI screen. A re-diagnosis result screen 1510 of FIG. 15B displays a message indicating that since the error has not been resolved by part replacement, the sales company has been contacted (S1310). A confirmation button 1511 is a button for closing this UI screen.

The flow of the operation in the image formation apparatus 104 received from the diagnosis result from the diagnosis server 101 is as described above. In the flow of above-mentioned FIG. 13, for example, in the case where a certain part has been replaced, if the result of the condition diagnosis before the replacement is erroneous for this part (NO in S1302), a re-diagnosis on the condition is automatically performed. Then, as a result of the condition re-diagnosis, if it is found that the state of this part is normal (that is, there is no initial failure·installation failure), it is also deemed that no image defect has occurred, and the diagnosis result screen 1500 as shown in FIG. 15A is displayed, and the management server 102 and the client terminal 103 are also notified of that effect. Such processing allows the user to save time and effort for performing an image diagnosis on the user's own after executing a remedy work such as part replacement to thereby check whether the printing defect has been resolved. Then, the sales company and the maintenance staff can also find that there is no error in the image formation apparatus 104 from the result of the condition diagnosis, which is automatically performed after the completion of the remedy work. Note that although in the present embodiment, in the automatic re-diagnosis after the completion of remedy, either the condition diagnosis or the image diagnosis is executed, the configuration is not limited to this. For example, in the case where both condition error and image defect have been detected in the initial diagnosis, the re-diagnosis may be performed for both condition diagnosis and image diagnosis.

### Modification 1

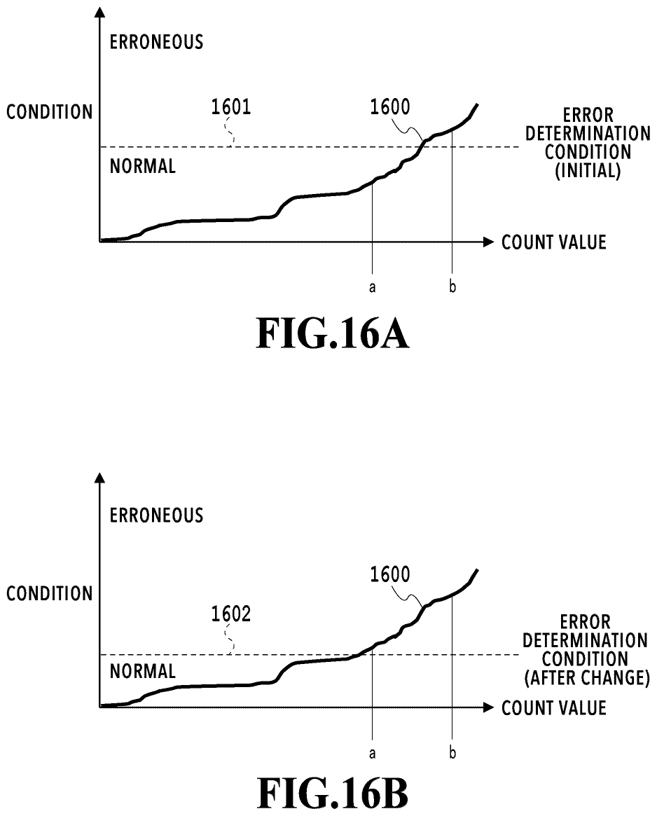

The error determination condition to be used in the condition diagnosis may be changed in accordance with the use state or the like of the image formation apparatus. FIGS. 16A and 16B are graphs showing examples of error determination conditions. FIG. 16A corresponds to initial setting and FIG. 16B corresponds to setting after a change. Now, the X axis of both graphs takes a count value of a sensor provided in an installation location of a certain part, and the Y axis thereof takes an evaluation value of a condition. Now, in both graphs, a curve 1600 indicating a change property of the evaluation value of the condition relative to the count value is common. In addition, dashed lines 1601 and 1602 in both graphs indicate thresholds as error determination conditions, each of which serves as a boundary between condition normal and condition error.

Here, it is assumed that it is empirically known that the performance of a certain part decreases due to degradation over time, and in order to ensure its function, it is necessary to lower a condition evaluation value serving as a threshold, in accordance with the accumulated time of use, the number of printed sheets, or the like so as to prevent erroneous determination. In this case, for example, the threshold as the error determination condition is lowered based on the cumulative number of prints or the like of the image formation apparatus 104.

Now, it is assumed that by the image diagnosis, an image defect has been found and a result that the cause of the image defect is in the above-described certain part is indicated. In the case where the error determination condition (threshold) of the condition relating to the certain part at this time is the dashed line 1601 in the graph of FIG. 16A, if the count value is “a”, the condition is determined to be normal. On the other hand, in the case where the error determination condition (threshold) at this time is the dashed line 1602 in the graph of FIG. 16B, even if the count value is “a”, the condition is determined to be erroneous, which matches the result that the image defect has been occurred. Note that a change·update of the error determination condition may be made automatically based on a parameter value which changes in accordance with a use state, such as the cumulative number of prints, of the image formation apparatus 104, or may be set manually by maintenance staff or the like.

In this way, by making the error determination condition for the condition diagnosis not fixed but variable to optimize the error determination condition, a condition diagnosis with high precision becomes possible for a larger number of cases.

### Modification 2

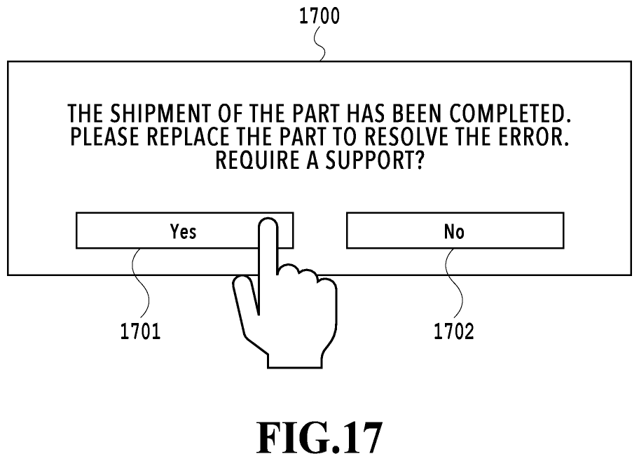

There is also a case where even if, for example, a part for replacement is shipped from the sales company to the user or the like in accordance with the result of the image diagnosis, the user or the like does not perform part replacement, or part replacement cannot be performed for some reason. In this case, the sales company cannot find whether the error of the image formation apparatus 104 has been resolved after the shipment of the part for a long time even by means of the approach of the above-mentioned embodiment. In view of this, in the case where part replacement cannot be confirmed even after the elapse of a predetermined period of time from the shipment of the part, the necessity of the support may be confirmed, such that if necessary, an additional correspondence such as dispatching a service person is taken. Specifically, first, it is confirmed that device state information containing a part replacement event has not been received from the image formation apparatus 104 even after the elapse of a predetermined period of time (for example, one week) from the time point at which the event management unit 612 received a shipment notification event of a part for replacement. Then, upon this confirmation, the GUI control unit 407 displays, on the operation panel 207, a UI screen urging the user to replace the part. FIG. 17 is an example of a UI screen to be displayed in this event. A UI screen 1700 of FIG. 17 contains a message indicating that the shipment of the part has been completed, a message urging the part replacement, and further, buttons 1701 and 1702 for confirming whether or not a support is required. In the case where the user pressed down the “Yes” button 1701, the communication control unit 404 transmits, to the sales company, a request for the dispatch of a service person by e-mail or the like. The user who does not require a support presses down the “No” button 1702 to close the UI screen, and then performs part replacement, and thereafter, the processing after the error remedy in accordance with the flowchart of aforementioned FIG. 13 is performed.

As described above, according to the present Modification, in the case where part replacement is not performed even if a certain period of time has elapsed after the dispatch of a part for replacement, it is possible to urge part replacement and resolution of an error. Moreover, in the case where the user has difficulty in part replacement, an appropriate support can be made.

As described above, according to the present embodiments including each Modification, the user can save time and effort for performing re-diagnosis after dealing with an error. In addition, even in the case where the user has not performed re-diagnosis, the maintenance staff or the sales company can check the resolution of the error.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, convenience in error diagnosis of an image formation apparatus is improved.

This application claims the benefit of Japanese Patent Application No. 2024-219794, filed Dec. 16, 2024 which is hereby incorporated by reference herein in its entirety.

What is claimed is:

1. A system which diagnoses an error in an image formation apparatus, comprising:
one or more memories storing instructions; and
one or more processors executing the instructions to perform, based on a diagnosis instruction of a user, a first diagnosis based on an image outputted from the image formation apparatus, and a second diagnosis based on condition information indicating a state of a part of the image formation apparatus, wherein
in a case where an error in the image formation apparatus and a remedy for resolving the error are specified by the first diagnosis or the second diagnosis based on the diagnosis instruction, and an execution of the remedy is confirmed, the second diagnosis based on the condition information after the execution of the remedy is automatically performed.

2. The system according to claim 1, wherein in a case where the execution of the remedy is confirmed, and an error in the image formation apparatus has been specified by the second diagnosis before the execution of the remedy, the second diagnosis based on the condition information after the execution of the remedy is automatically performed.

3. The system according to claim 1, wherein the remedy is any of replacement of the part, cleaning of the part, and repair of the part.

4. The system according to claim 1, wherein in a case where the remedy specified by the first diagnosis or the second diagnosis based on the diagnosis instruction is replacement of the part, and the replacement of the part is detected in the image formation apparatus, the second diagnosis based on the condition information after the execution of the remedy is automatically performed.

5. The system according to claim 1, wherein in a case where the remedy specified by the first diagnosis or the second diagnosis based on the diagnosis instruction is cleaning or repair of the part, and information indicating a completion of the cleaning or repair of the part is inputted via a user interface of the image formation apparatus, the second diagnosis based on the condition information after the execution of the remedy is automatically performed.

6. The system according to claim 1, wherein the first diagnosis or the second diagnosis based on the diagnosis instruction is executed in an information processing apparatus capable of communicating with the image formation apparatus.

7. The system according to claim 6, wherein the information processing apparatus outputs, to an external apparatus, a result of the second diagnosis based on the condition information after the execution of the remedy.

8. The system according to claim 7, wherein
the external apparatus is the image formation apparatus, and
a user interface screen containing the result of the second diagnosis based on the condition information after the execution of the remedy is displayed on an operation panel of the image formation apparatus, the result being outputted from the information processing apparatus.

9. The system according to claim 8, wherein in a case where the remedy specified by the first diagnosis or the second diagnosis based on the diagnosis instruction is replacement of the part, and part replacement cannot be confirmed even after a predetermined period of time has elapsed from shipment of the part, the user interface screen containing a message urging replacement of the part is displayed on the operation panel of the image formation apparatus.

10. The system according to claim 9, wherein
in the user interface screen containing the message urging the replacement of the part, there is a button for confirming whether or not a support is required, and
in a case where information indicating that the support is required is inputted via the user interface screen, a request for dispatch of a service person is made to a third party in charge of maintenance management of the image formation apparatus.

11. The system according to claim 8, wherein the external apparatus is an information processing apparatus used by a third party in charge of maintenance management of the image formation apparatus.

12. The system according to claim 11, wherein in a case where the remedy specified by the first diagnosis or the second diagnosis based on the diagnosis instruction is replacement of the part, and an error in the image formation apparatus is found by the second diagnosis automatically performed, notification indicating that the error has been found is made to the information processing apparatus used by the third party.

13. The system according to claim 8, wherein the external apparatus is an information processing apparatus used by the user or maintenance staff of the image formation apparatus.

14. The system according to claim 1, wherein the second diagnosis is performed by comparing a value indicating the state of each part indicated by the condition information and a threshold prepared in advance.

15. The system according to claim 14, wherein the threshold is variable.

16. The system according to claim 15, wherein the threshold is changed based on a parameter value which changes in accordance with a use state of the image formation apparatus.

17. A method for controlling a system which diagnoses an error in an image formation apparatus, the method causing a computer to:
perform, based on a diagnosis instruction of a user, a first diagnosis based on an image outputted from the image formation apparatus, and a second diagnosis based on condition information indicating a state of a part of the image formation apparatus; and
specify an error in the image formation apparatus and a remedy for resolving the error, by the first diagnosis or the second diagnosis based on the diagnosis instruction, and in a case where an execution of the remedy is confirmed, automatically perform the second diagnosis based on the condition information after the execution of the remedy.

18. A non-transitory computer readable storage medium storing a program for causing a computer to perform a method for controlling a system which diagnoses an error in an image formation apparatus, the method comprising:
performing, based on a diagnosis instruction of a user, a first diagnosis based on an image outputted from the image formation apparatus, and a second diagnosis based on condition information indicating a state of a part of the image formation apparatus; and
specifying an error in the image formation apparatus and a remedy for resolving the error, by the first diagnosis or the second diagnosis based on the diagnosis instruction, and in a case where an execution of the remedy is confirmed, automatically performing the second diagnosis based on the condition information after the execution of the remedy.
